(19) United States
(12) Patent Application Publication
(10) Pub. No.: US 2026/0049022 A1
(43) Pub. Date: Feb. 19, 2026

(54) Recycling of Glass from Solar Modules

(71) Applicant: SOLARCYCLE, inc., Mesa, AZ (US)

(72) Inventors: Pablo RIBEIRO DIAS, Mesa, AZ (US); Robert VINJE, Mesa, AZ (US)

(21) Appl. No.: 18/746,959

(22) Filed: Jun. 18, 2024

Related U.S. Application Data
(60) Provisional application No. 63/509,009, filed on Jun. 19, 2023.

(51) Int. Cl. C03C 1/02; C03B 5/00; C03C 1/00

(52) U.S. Cl. CPC C03C 1/02; C03B 5/005; C03C 1/002

(57) ABSTRACT

Methods and apparatuses recycle glass from used solar modules. Particular embodiments combine optical interrogation such as X-Ray Fluorescence (XRF) with computer-controlled dispensing, in order to obtain refined glass having substantially uniform properties. Such glass properties can include but are not limited to one or more of: ⋅elemental content (e.g., Iron), ⋅optical transmittance, ⋅physical resilience (e.g., resistance to weather damage), and ⋅texture—e.g., to assist in forming an anti-reflective coating (ARC) and/or encapsulant adhesion. Such optical interrogation is combined with computer-controlled dispensing that regulates the release of glass material through a gate, until one or more specific criterion are met.

### CROSS-REFERENCE TO RELATED APPLICATION

The instant nonprovisional patent application claims priority to U.S. Provisional Patent Application No. 63/509,009, filed Jun. 19, 2023 and incorporated by reference in its entirety herein.

### BACKGROUND

As world population increases, the earth is subjected to escalating environmental stress. One form of stress is manifest in rising global temperatures attributable to the burning of fossil fuels in order to provide energy needs.

Alternative energy sources can provide power, while lessening the carbon dioxide burden on the planet. One important source of alternative energy is solar power.

Solar modules are complex manufactured items. They harness the sun's energy and convert it into a usable energy source for residential, commercial and utility-scale applications. As the climate has been significantly impacted by the use of fossil fuels over the past century, the need for alternative sources of energy like solar has taken on greater importance.

Some solar modules include glass. The glass may serve as a protective layer, admitting the light while excluding outside unwanted agents such as dirt, dust, and others.

### SUMMARY

Embodiments relate to methods and apparatuses that recycle glass from used solar modules. Particular embodiments combine optical interrogation such as X-Ray Fluorescence (XRF), with computer-controlled dispensing, in order to obtain refined glass having substantially uniform properties. Such glass properties can include but are not limited to one or more of: ⋅ elemental content (e.g., Iron), ⋅ optical transmittance, ⋅ physical resilience (e.g., resistance to weather damage), and ⋅ texture—e.g., to assist in forming an anti-reflective coating (ARC) and/or encapsulant adhesion. One form of optical interrogation that may be used, is X-Ray Fluorescence. Such optical interrogation is combined with computer-controlled dispensing that regulates the release of glass material through a gate, until one or more specific criterion are met. In certain embodiments, such criteria could be optical interrogation results.

### BRIEF DESCRIPTION OF THE DRAWINGS

FIG. 1 shows a simplified block diagram of a system configured to implement glass handling according to an embodiment.

FIG. 2 shows a simplified cross-sectional view of one embodiment of an apparatus that may be utilized for glass recycling.

FIG. 3 shows an enlarged view of a dispenser according to an embodiment.

FIG. 4 shows an embodiment featuring a rotating latch at the bottom of the dispenser.

FIG. 5 shows a simplified cross-section of a dispenser embodiment having multiple x-ray fluorescence (XRF) devices arranged in sequence.

FIG. 6 shows an embodiment featuring virgin glass raw materials (here, from respective, dedicated dispensers), in order to afford the ability to control the properties of the glass that is being output.

FIGS. 7 and 8 show embodiments that include metallic and/or foreign material separation for the recycled glass cullets.

FIGS. 9A-B show side and top views, respectively, of an alternative embodiment featuring multiple batch houses.

FIG. 10 shows a simplified cross-section of a solar module.

FIG. 10A shows a simplified plan view of a solar module.

### DESCRIPTION

Solar modules exist in a variety of types and architectures. Examples of such modules can include but are not limited to:
Monocrystalline Solar Panels (Mono-SI)
Polycrystalline Solar Panels (p-Si)
Amorphous Silicon Solar Panels (A-SI)
Cadmium telluride photovoltaics (CdTe)
Copper indium gallium selenide modules (CIGS)
Copper indium selenide modules (CIS)
Concentrated PV Cell (CVP)
Biohybrid Solar modules
Monofacial modules
Bifacial modules
Modules without encapsulant
Silicon heterojunction solar modules
tunnel oxide passivated contact solar modules (TOPCON)
passivated emitter and rear contact solar modules (PERC)
Tandem-junction Solar Panels
Perovskite-based Solar Panels
Glass-Backsheet Solar Panels
Glass-Glass Solar Panels
Building-Integrated Solar Panels
Polymer-Based Solar Panels
Solar Roof Tiles
Solar Roof Shingles

Solar modules can last decades, with some degradation in performance over a module's lifetime. Also, solar modules that have been deployed on residential rooftops and other commercial and utility-scale applications for a number of years, may be decommissioned for a variety of reasons.

For example, (residential, commercial, utility) users of solar panels may desire to exchange their modules for newer, higher performing modules in order to maximize the amount of energy obtained from a solar array.

As more solar modules reach the end of their useful lives and/or are relinquished by their owners, it is desirable to dispose of the panels in an environmentally-friendly and economically-feasible way. Alternatively, it may be desired to refurbish and reuse existing solar modules to prolong their lifetimes and reduce cost.

Once it is determined that a solar module is no longer useful to its owner, e.g.:
the module has reached the end of its current deployment due to non-or underperformance,
the module has been damaged in transit, or
for other (e.g., economic) reasons,
   in order to avoid discarding the module into a landfill, the module may either be recycled or refurbished and reused.

Accordingly, to determine whether a solar module should be recycled or refurbished and reused, embodiments may implement one or more of the following processes, alone or in various combinations and sequences.
cleaning;
inspection to Determine Reusability;
testing;
remove cabling;
remove frames surrounding the panel and/or junction boxes (either manually, or e.g., using an automated deframing machine).
transparent front layers and potentially other layers (e.g., the backsheet) may be removed using a delamination process.

Remaining layers (of, e.g., a laminate) may be shredded. Shredded materials can be separated using one or more processes in order to extract various possible reusable materials therefrom (e.g., valuable commodity metals such as silicon, silver, and/or copper).

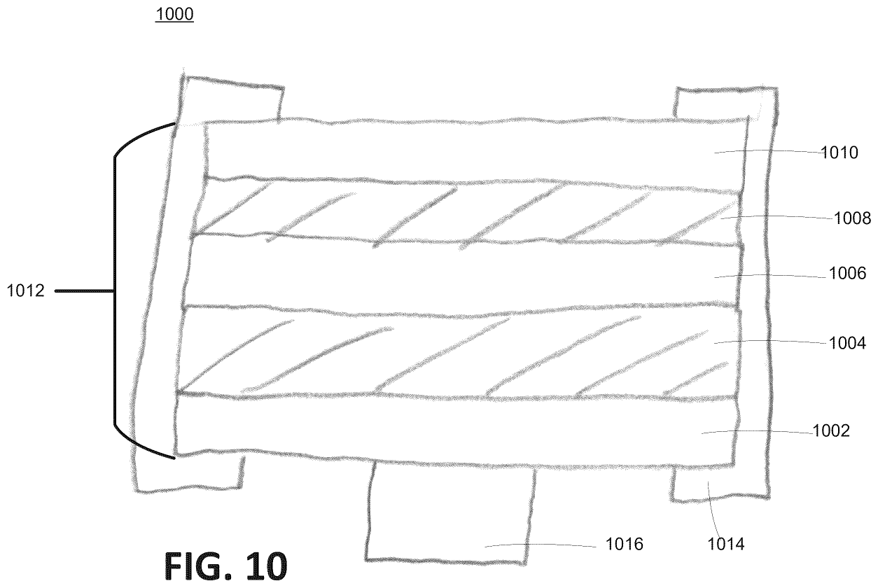

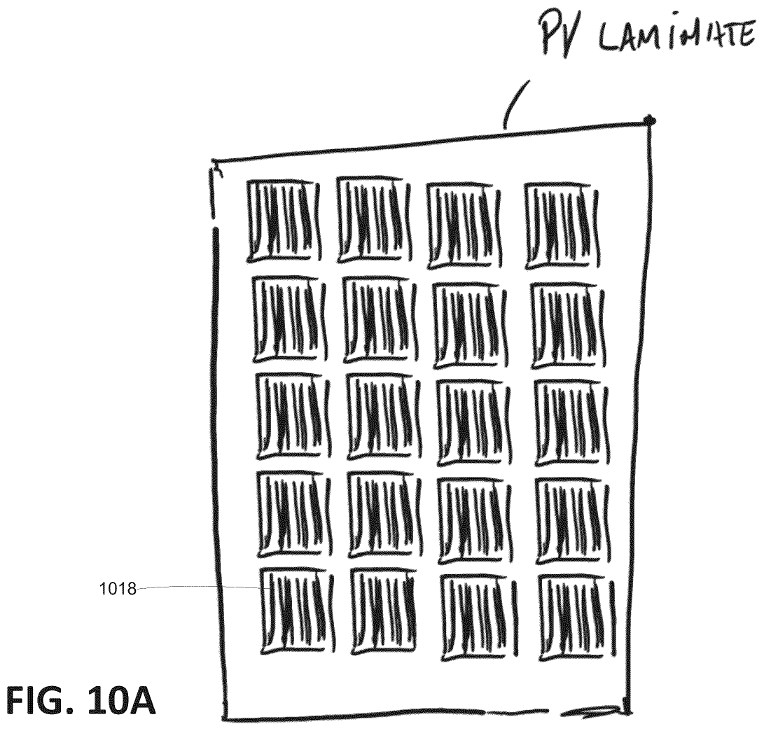

Embodiments relate to various techniques that may be employed, alone or in combination, for the recycling and/or refurbishment of solar modules. FIG. 10 shows a cross-sectional view of a monofacial solar module according to an example.

The PV module 1000 is made of different layers assembled into the structure shown in FIG. 10. These layers of FIG. 10 are not drawn to scale.

The layers of FIG. 10 can be simplified as:
substrate (backsheet) 1002,
back encapsulant 1004, e.g., Ethylene-vinyl acetate (EVA), silicone, Polyvinyl butyral (PVB), IONOMER, polyolefin elastomer (POE)
solar cell 1006 comprising PV material (including, e.g., but not limited to: doped single crystal, polycrystalline, or amorphous silicon, Group III-V materials) and metallization,
front encapsulant 1008,
transparent front cover sheet 1010 (e.g., typically glass).
   This grouping of layers is referred to as a laminate 1012.

It is further noted that bifacial modules also exist. Such bifacial modules may exhibit a structure similar to that of FIG. 10, but have a transparent (e.g., glass) layer instead of a backsheet layer. This allows (e.g., reflected) light to enter the module from the back.

The laminate in FIG. 10 is surrounded by a frame 1014. The frame may comprise a stiff metal such as aluminum. Alternatively, a frame material may be plastic, comprising e.g., polycarbonate.

A junction box 1016 is also part of the module. The junction box may be potted (more common in newer models) or non-potted (more common in older models). In a potted PV junction box, the foils coming out of the solar panel are soldered to the diodes in the junction box, and the junction box is potted or filled with a type of sticky material to allow thermal transfer of heat to keep the solder joint in place and prevent it from falling. Fabrication may take longer but creates a better seal.

In the non-potted PV junction box, a clamping mechanism is used to attach the foil to the wires in the junction box. This can involve a faster assembly, but may not be as robust. A module having a potted junction box may be more amenable to recycling or refurbishment.

FIG. 10A shows a simplified overhead view of the laminate of a solar module, lacking the frame and the top transparent sheet. FIG. 10A shows solar cells including patterned metallization 1018, which may comprise, e.g., a valuable metal such as silver.

Embodiments relate to methods and apparatuses that recycle glass from used solar panels. Particular embodiments combine optical interrogation such as X-Ray Fluorescence (XRF), with computer-controlled dispensing, in order to obtain refined glass having substantially uniform properties. Such glass properties can include but are not limited to:
elemental content (e.g., Iron)
optical transmittance;
physical resilience (e.g., resistance to weather damage);
texture—e.g., to assist in forming an anti-reflective coating (ARC) and/or encapsulant
adhesion;
surface roughness;
size;
hardness;
compressive strength.
thermal stability.

One form of optical interrogation that may be used, is X-Ray Fluorescence. There, X-Rays are applied to excited atoms, and their decay is measured to determine type and/or amount of atoms in a given region/volume.

Such optical interrogation is combined with computer-controlled dispensing. Such computer-controlled dispensing regulates the release of glass material through a gate, until one or more specific criterion are met. In certain embodiments, such criteria could be optical interrogation results.

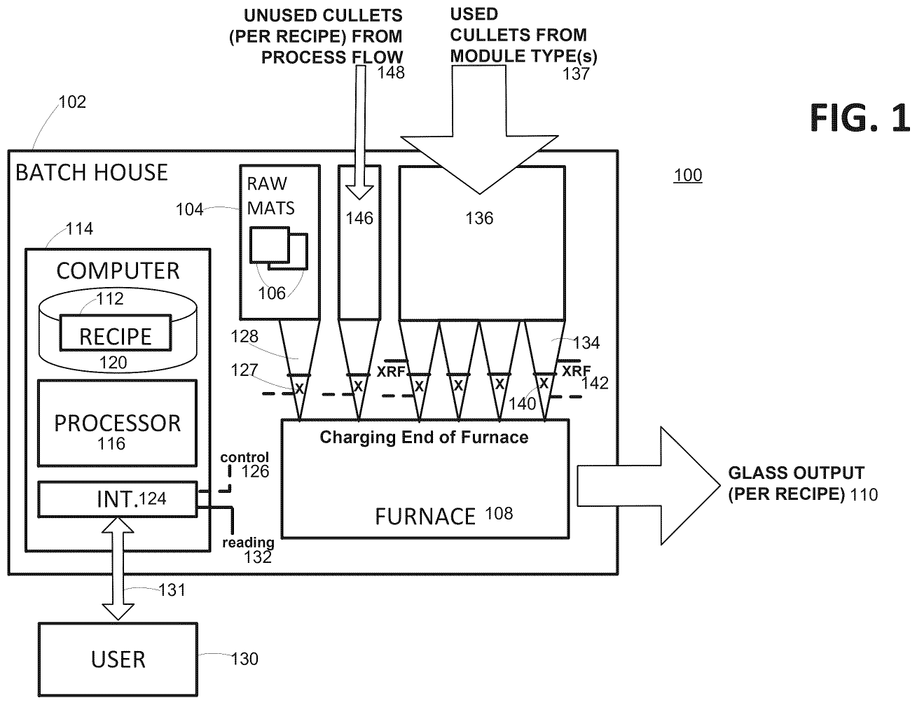

FIG. 1 shows a simplified block diagram of a system 100 that is configured to implement glass handling according to an embodiment. Specifically, batch house 102 comprises a plurality of raw materials 104, that are of specified purities.

The individual raw materials may be stored separately from each other in respective compartments 106. For example, separate/dedicated compartments may be used to store respectively:
soda ash,
silica sand,
limestone, and
other materials.

The batch house is also responsible for dispersing the raw materials in appropriate quantities to the melting furnace 108. The resulting output 110 is glass that conforms to a particular recipe 112—i.e., exhibits desired optical and physical properties.

The proportion of materials going into the melting furnace (i.e., the recipe) can be carefully regulated. A single glass melting furnace may maintain a same uniform recipe over long periods of time (e.g., months) to achieve consistent output. This avoids issues arising during other stages of the glass manufacturing process (e.g., rolling, cutting, annealing, tempering, others).

The physical dispensing of materials into the furnace, is accomplished by the action of a computer 114. In particular, the computer comprises a processor 116 and a non-transitory computer readable storage medium 120 (e.g., a database) including the recipe.

The computer further comprises an interface 124. Based upon control signals that are communicated along control lines 126 to gate(s) 127 of dispenser(s) 128, the raw materials are delivered to the furnace to create the glass conforming to the desired recipe. That glass is in turn output from the furnace for incorporation into solar modules.

The interface also allows communication with the user 130 of the batch house. Interaction 131 with the interface, affords the user with the ability to control the materials entering the furnace, and to monitor the process of glass formation.

The computer is further in communication with reading lines 132. In particular, these reading lines receive measurement data from a plurality of dispensers 134 that are in communication with a chute 136, also referred to herein as a doghouse. The chute is configured to receive a plurality of glass cullets 137 obtained from used solar modules of various types (e.g., having glass with different properties).

The dispensers are deployed in communication with the chute. The dispensers are equipped with respective gates 140 that are linked to the processor via control lines.

The dispensers further comprise a respective optical interrogation device 142 (e.g., XRF) coupled to the contents of the respective dispenser. Readings from the optical interrogation device, are sent to the processor via the reading lines.

Based upon signals sent along the reading lines, the processor may operate to selectively activate a gate of a respective dispenser of used cullets. In this manner, used cullets may be selectively added to the furnace, and thereby contribute to the formation of the glass per the recipe.

It is noted that the system of FIG. 1 also includes a bin 146 comprising unused glass cullets 148. These unused glass cullets are taken from the process flow for fabricating the glass. In this manner, purified glass material that conforms to the recipe, but which has been incidentally broken during the glass fabrication process flow, is not wasted but rather reused in order to create more glass.

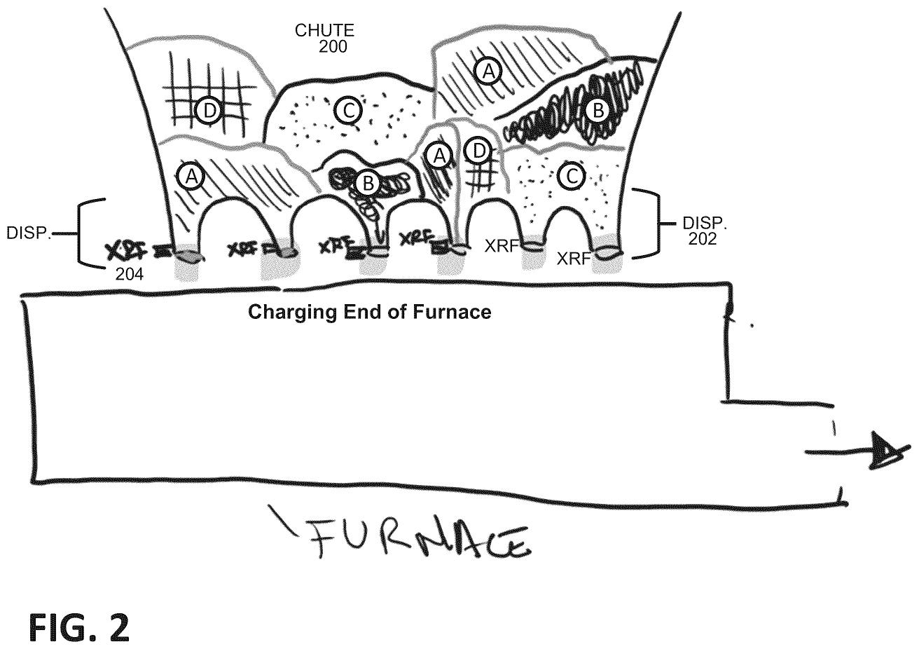

FIG. 2 shows a simplified cross-sectional view of one embodiment of an apparatus that may be utilized for glass recycling. A chute 200 is configured to receive glass cullets. Here, glass cullets of different types (A-D) are shown. Such glass cullets could:
originate from different sources (e.g., used modules), and/or
be the product of different types of pre-processing to separate the glass from the solar module.

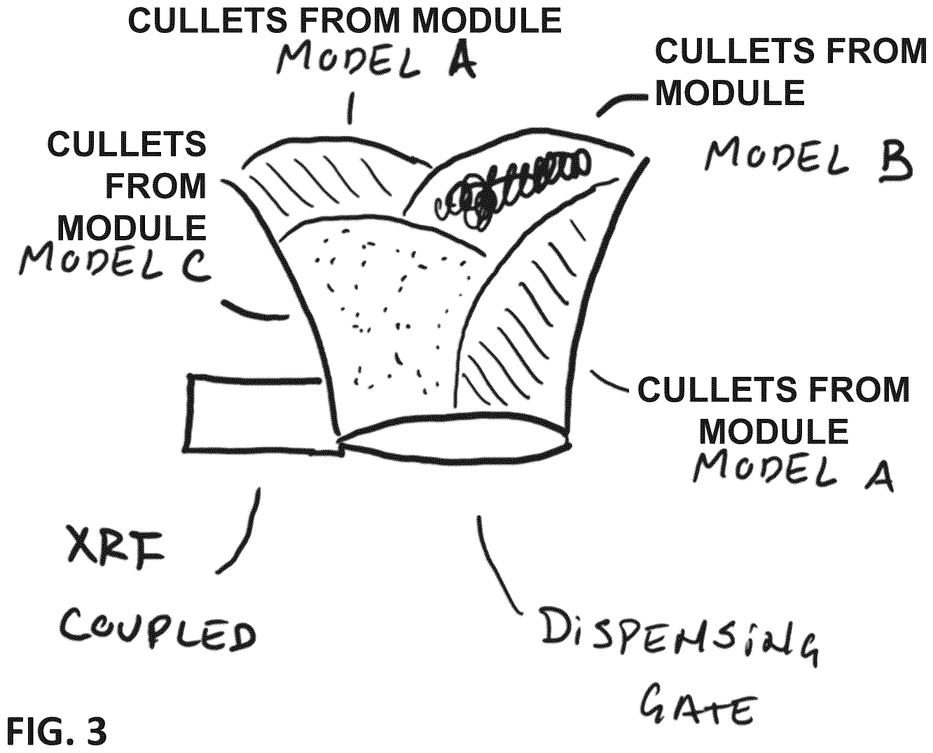

A plurality of dispensers 202 are in communication with the chute. FIG. 3 shows an enlarged view of a dispenser.

Each dispenser would have XRF equipment 204 coupled to the end of the dispenser. That XRF equipment measures the properties of glass.

In particular, the XRF equipment could measure atomic composition of the cutlet in the dispenser, determining amounts one or more of the following materials, if present:
Al;
Fe;
Mg;
Si;
Cu;
Ag
Sb;
Pb;
As;
Polymer(s)

In some embodiments the XRF is online. In such embodiments, x-rays may be emitted on an ongoing basis, with returning x rays measured and the corresponding reading being fed back to a computer continuously as part of the line.

It is noted that the XRF could be positioned to read a full volume of the dispenser.

Alternatively, the XRF could analyze only a partial dispenser volume, and assume the remainder to be of a same or similar makeup. Accordingly, various embodiments may utilize one or more of the following techniques.
1) Statistical sampling. Analysis of all materials may not be required. Rather, some embodiments may constantly or periodically take measures of a fraction of the content. The readings from that fraction may be used to expand to the total population.
2) Laboratory testing and database creation. While the various cullet types may be co-mingled, their sources may be known in advance. That is, a universe of known cullet types is available, and each of those types may have corresponding signature. By knowing beforehand a range of possible options to be dealt with, the computation to infer the total population may be reduced.
3) Machine Learning. Machine learning approaches may tie together 1) and 2). Training can be accomplished by taking samples from the batch house equipment (and its corresponding reading) and analyzing in the laboratory for high precision result. The machine learning can be corrected and/or reinforced as a result.

A reading from the XRF equipment can be sent to a computer for processing. In particular, the computer may determine from the reading, an amount of glass to be dispensed on a per-cullet basis.

The apparatus of FIG. 2 has several dispensing gates. This increases the possibility of finding a glass cullet that matches the recipe needs.

Certain embodiments could employ multiple dispensers (e.g., >100 in particular embodiments) that would allow for rapid dispensing on a per cullet basis. In this manner, the incoming glass does not need to be sorted prior to putting it into the manufacturing process, in order to be controlled under specific requirements.

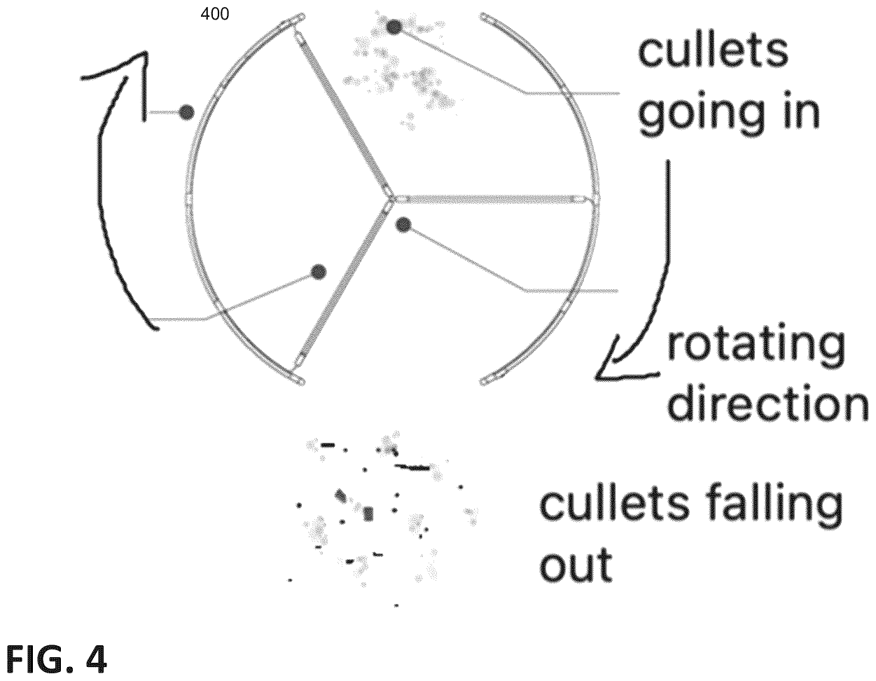

It is noted that cullet analysis and/or dispensing need not take place on a per-cullet basis. Alternatively, fewer dispensers (e.g. between about 10-50 in particular embodiments) could be used to dispense a batch of cullets at a time, by adjusting the frequency of the opening mechanism. FIG. 4 shows one possible approach, featuring a rotating latch 400 at the bottom of the dispenser.

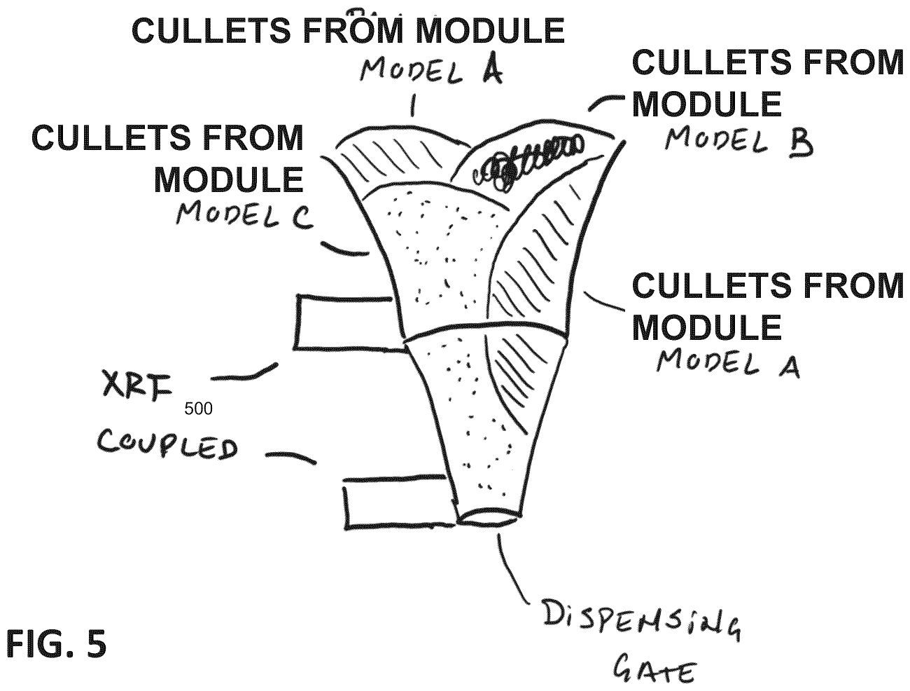

In particular embodiments, multiple XRF devices can be utilized to enhance precise control. FIG. 5 shows a simplified cross-section of a dispenser embodiment having multiple XRF devices 500 arranged in sequence.

Here, the XRF device proximate to the dispensing gate measures what is being placed in the furnace. The XRF device distal from the dispensing gate measures differences in properties of the incoming glass cullet.

Thus in the multi-XRF approach of the embodiment of FIG. 5, the initial XRF reading informs as to whether incoming glass is from a single source (e.g., PV module model a or b or c, or whether the incoming glass is instead from multiple sources (e.g., different PV module models). The second XRF reading is taken closer to the dispenser, and indicates what is actually being dispensed.

In this manner, the first XRF allows for planning on building a recipe. The later XRF indicates what actually went into the furnace, and whether or not adjustment is appropriate.

According to some embodiments, the chute and/or individual dispenser can be equipped with a vibration mechanism in order to promote movement of the glass cullets.

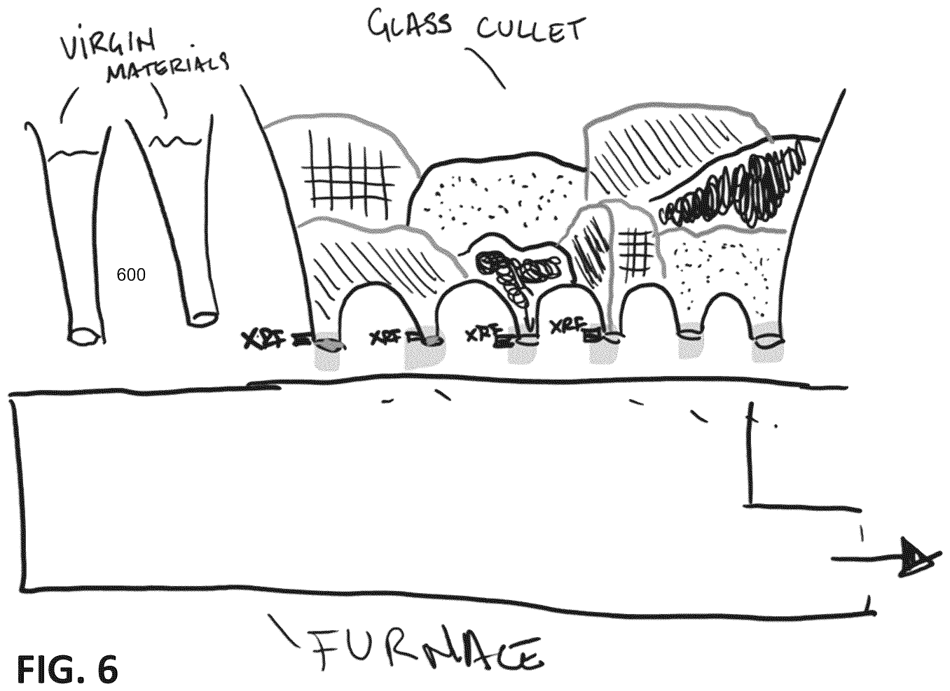

It is not required that the chute, dispenser, and/or furnace contain only previously used glass. As shown in FIG. 6, particular embodiments may also feature virgin glass raw materials (here, from respective, dedicated dispensers 600), in order to afford the ability to control the properties of the glass that is being output. Instruction to open the gate of such a dispenser can be available to batch house operators.

Moreover, yet another dispenser could contain cullets from the module manufacturing process (e.g., allowing reuse of glass that is unintentionally broken during module fabrication). Again, instruction to open the gate of such a dispenser can be available to batch house operators.

While the particular embodiment of FIG. 1 shows the furnace in the batch house, this is not required. Certain embodiments could feature the furnace as separate and downstream from the batch house.

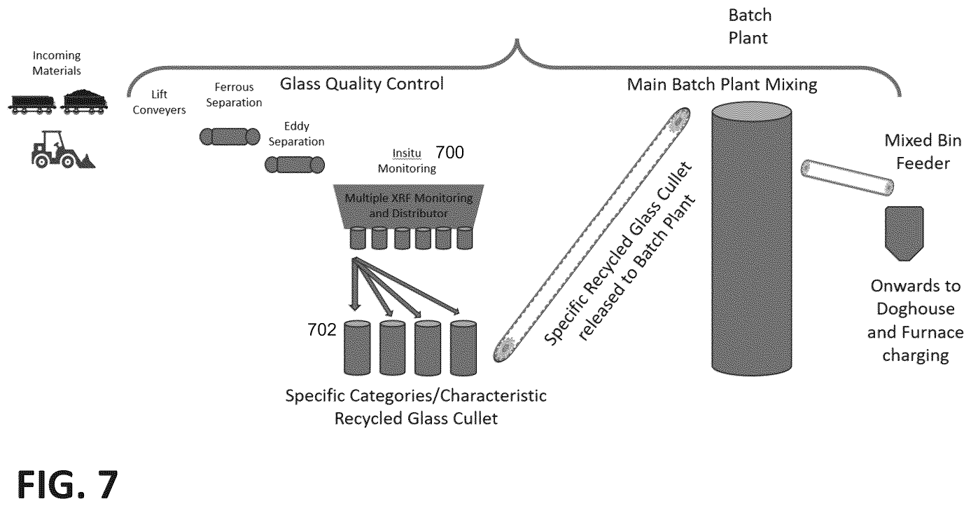

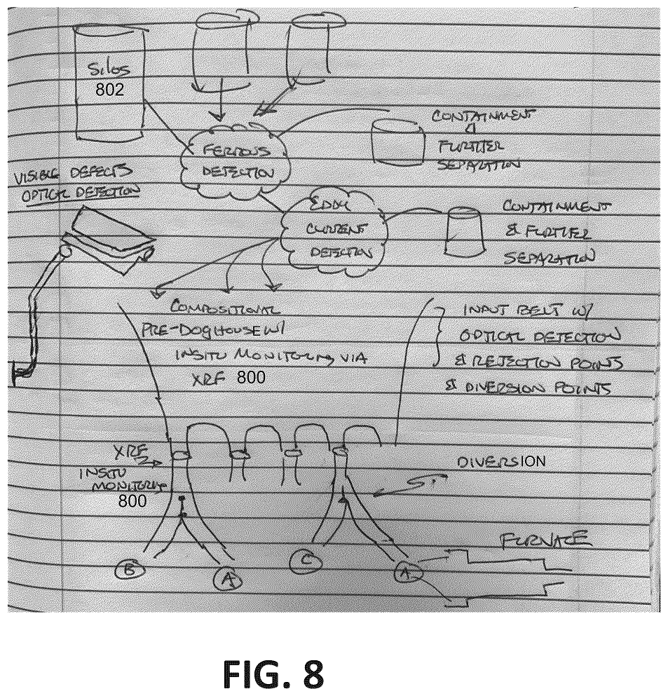

Embodiments are not limited to the particular activities shown in the previous figures. For example, the embodiments shown in FIGS. 7 and 8 also include metallic and/or foreign material separation for the recycled glass cullets. These activities can facilitate efficient use of the cullets coming from multiple factories and internal or external sources.

Moreover, embodiments are not limited to a particular sequence of events, and activities can occur at different locations. For example, FIG. 7 shows how insitu monitoring 700 can be done prior to the main batch house silos, allowing an earlier separation of like recycled glass cullets material.

Separation according to embodiments, can comprise one or more of:
optical separation (e.g., XRF)
physical separation (e.g., sieving, electrostatic, eddy current, magnetic, gravimetric, and other forms of density separation between glass and iron)
Ferrous detection (magnetic separation)
chemical separation (e.g. leaching; acid washing)
others.

An objective of separation may be to remove possible iron contamination. Such external iron contamination can arise from sources such as:
dust/dirt during PV module field operation,
dust/dirt during transportation of used PV module,
steel from machinery during PV module recycling process,
steel from transportation of recycled material to glass furnace/factory,
containers/dispenser/conveyers.

In FIG. 7, the incoming recycled glass cullet goes through metallic quality controls (magnetic and/or eddy current separation, optical separation), and then goes into the insitu monitoring hopper. There, XRF monitoring and closed loop feedback sends specific categories and like types of recycled glass cullets onwards to separate small silo batch storage units (or onwards to the main batch house) for mixing then onwards to the mixed batch bin feeder and doghouse feeder located on a charging end of the furnace.

FIG. 8 shows a specific embodiment where insitu monitoring 800 is done downstream of the main batch house silos. In FIG. 8, the circled A represents a diversion route to the mixed batch bin feeder and furnace entry points via the doghouse injection on charging end (injection point of feed material to melt) of furnace. The circled B and C represent diversion loops to sort glass into a specific grouping (X no. of groupings) or a full reject bin for unusable material.

FIG. 7 thus depicts activities occurring earlier in the transport of recycled cullet, where it is easier to divert through larger scale separation methods (e.g., physical, ferrous, or optical quality inspections). Such larger scale separation methods align well with the use of belts and/or conveyers flowing varying levels of material, and thus act as a coarse filter.

By contrast, FIG. 8 depicts a downstream separation that can loop smaller fluctuations back for more even mixing, thereby acting as a fine and final filter. Thus FIG. 7 has larger scale separators integrated in between raw materials and conveyance that is part of the storage silo areas, refined areas, and areas prior to entry into the batch house. The silos 702 in FIG. 7 are large capacity (e.g., outside) silos, whereas the silos 802 of FIG. 8 are positioned after the batch house.

Embodiments may also achieve homogenization of a batch in a multi-phase process. That is, the different cullets coming from different panels may be mixed into a consistent recipe for the new glass in multiple stages.

A first stage takes glass coming from different sources, mixes that glass, and melts it into a single glass formulation. Then, such glass formulation is measured to obtain the chemistry of the mix, and then either broken into cullets again or to drain molten glass in a spray of water to get fine cullet (called “sugar cullet”), and then used it in the second stage. That second stage is the actual making of the glass to be used in the solar module.

While the above figures show specific embodiments comprising a single batch house, this is not required. Alternative embodiments could feature multiple batch houses.

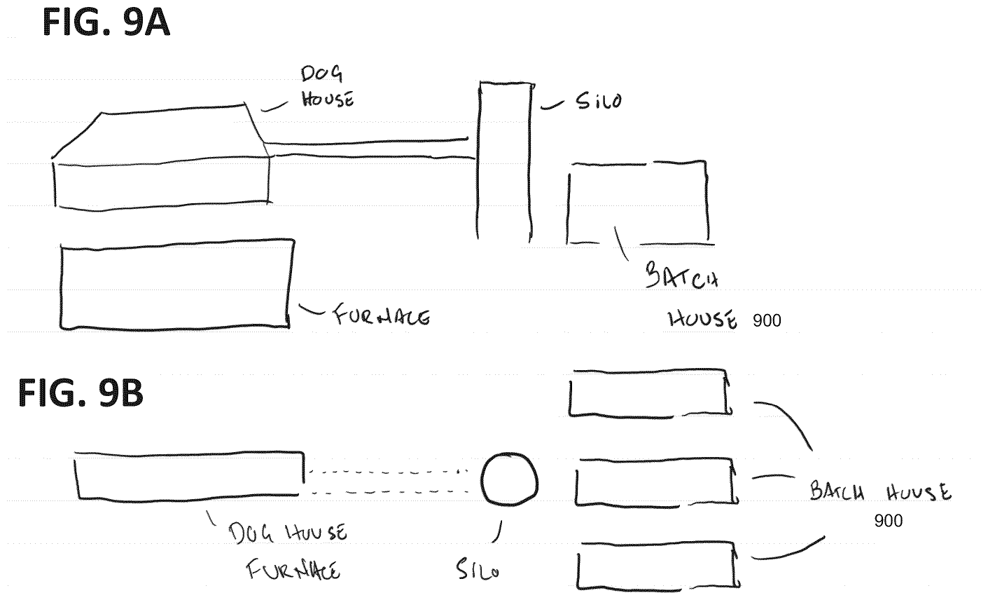

FIGS. 9A-B show side and top views, respectively, of an alternative embodiment featuring multiple batch houses 900. Here, glass cullets and/or recipes are sorted to impart flexibility in not being bound to the chemical composition of a particular cullet.

Embodiments may offer one or more benefits. One possible benefit is that because recycled glass already has a chemistry that is acceptable by the industry, it can serve as raw material of sufficient purity.

Thus, using recycled glass cullet can reduce the raw material requirements, and reduce the cost of sourcing the raw materials.

Another possible benefit is that the introduction of recycled glass cullets can lower a temperature needed to melt the other ingredients. This translates into a process that is cheaper, requires less energy and is more environmentally friendly.

Embodiments can offer valuable flexibility in glass production, affording the use of a variable percentage of post-consumer recycled glass in the mixtures. For example, by mixing before the furnace (in the batch house), embodiments permit measurement of the chemistry of the cullet going in, and aim for maximum cullet content without overshooting any of the chemistry restrictions of the recipe.

In one particular example, assume the dispenser puts 5 wt % of glass cullet, and notices that the iron (Fe) content is too high. The other 95 wt % virgin raw material can be used to balance out such iron content to that of the recipe. Then 5 wt % is the maximum cullet content in this batch.

In another particular example, 80 wt % cullet may be dispensed, before requiring virgin content to balance the recipe.

In still another particular example, the chemistry of used glass may be so close to the recipe that it dispenses ˜100 wt % cullet. Only minimal (or none) virgin material may be dispensed to balance out the chemistry.

Clause 1A. A method comprising:
receiving a reading of optical interrogation of a used glass cullet; and
processing the reading according to a recipe to dispense the used glass cullet into a furnace.

Clause 2A. A method as in Clause 1A wherein the used glass cullet is from a solar module.

Clause 3A. A method as in any of Clauses 1A or 2A wherein the reading comprises X-Ray Fluorescence of the used glass cullet.

Clause 4A. A method as in any of Clauses 1A, 2A, or 3A wherein based upon the processing, also dispensing an unused glass cullet from a solar module into the furnace.

Clause 5A. A method as in any of Clauses 1A, 2A, 3A, or 4A wherein based upon the processing, also dispensing a raw material into the furnace.

Clause 6A. A method as in any of Clauses 1A, 2A, 3A, 4A, or 5A wherein the reading indicates an iron content of 150 ppm or less.

Clause 7A. A method as in any of Clauses 1A, 2A, 3A, 4A, 5A, or 6A wherein the recipe specifies a transmittance of 91% or greater.

Clause 8A. A method as in any of Clauses 1A, 2A, 3A, 4A, 5A, 6A, or 7A further comprising dispensing into the furnace, another used glass cullet from another used solar module.

Clause 9A. A method as in Clause 8A wherein the reading is also of the another used glass cullet.

Clause 10A. A method as in any of Clauses 1A, 2A, 3A, 4A, 5A, 6A, 7A, 8A, or 9A wherein processing the reading comprises statistical sampling.

Clause 11A. A method as in any of Clauses 1A, 2A, 3A, 4A, 5A, 6A, 7A, 8A, 9A, or 10A wherein processing the reading comprises referencing a database created from testing.

Clause 12A. A method as in any of Clauses 1A, 2A, 3A, 4A, 5A, 6A, 7A, 8A, 9A, 10A, or 11A wherein processing the reading comprises machine learning.

Clause 13A. A method as in Clause 12A wherein the machine learning is trained by taking samples from a batch, and laboratory testing.

Clause 14A. A method as in any of any of Clauses 1A, 2A, 3A, 4A, 5A, 6A, 7A, 8A, 9A, 10A, 11A, 12A, or 13A further comprising:
receiving a previous reading of optical interrogation of the used glass cullet; and
prior to the dispensing, storing the used glass cullet based on the previous reading.

Clause 15A. A method as in any of Clauses 8A, 9A, 10A, 11A, 12A, 13A, or 14A wherein the used glass cullet and the another used glass cullet are stored as separate batches.

Clause 16A. A method as in any of Clauses 8A, 9A, 10A, 11A, 12A, 13A, 14A, or 15A wherein the used glass cullet and the another used glass cullet:
have different elemental content;
have different transmittance; and/or
result from different pre-processing.

Clause 17A. A method as in any of Clauses 8A, 9A, 10A, 11A, 12A, 13A, 14A, 15A, or 16A wherein:
the furnace melts the used glass cullet and the another used glass cullet into a glass formulation; and
the method further comprises:
making a new solar module from the glass formulation.

Clause 18A. A method as in Clause 17A wherein the new solar module is made from a sugar cullet of the glass formulation.

Clause 19A. A method as in any of Clauses 8A, 9A, 10A, 11A, 12A, 13A, 14A, 15A, 16A, 17A or 18A wherein the another used glass cullet is a product of magnetic separation.

Clause 20A. A method as in any of Clauses 8A, 9A, 10A, 11A, 12A, 13A, 14A, 15A, 16A, 17A, 18A, or 19A wherein the another used glass cullet is a product of Eddy current separation.

Clause 21A. A method as in any of Clauses 1A, 2A, 3A, 4A, 5A, 6A, 7A, 8A, 9A, 10A, 11A, 12A, 13A, 14A, 15A, 16A, 17A, 18A, 19A, or 20A wherein the used glass cullet is a product of magnetic separation.

Clause 22A. A method as in any of Clauses 1A, 2A, 3A, 4A, 5A, 6A, 7A, 8A, 9A, 10A, 11A, 12A, 13A, 14A, 15A, 16A, 17A, 18A, 19A, 20A, or 21A wherein the used glass cullet is a product of eddy current separation.

It is emphasized that depending upon the particular embodiment, the above approaches may be utilized alone or in various combinations.

What is claimed is:

1. A method comprising:
receiving a reading of optical interrogation of a used glass cullet from a solar module; and
processing the reading according to a recipe to dispense the used glass cullet into a furnace.

2. A method as in claim 1 wherein the reading comprises X-Ray Fluorescence of the used glass cullet.

3. A method as in claim 1 wherein based upon the processing, also dispensing an unused glass cullet into the furnace.

4. A method as in claim 1 wherein based upon the processing, also dispensing a raw material into the furnace.

5. A method as in claim 1 wherein the reading indicates an iron content of 150 ppm or less.

6. A method as in claim 1 wherein the recipe specifies a transmittance of 91% or greater.

7. A method as in claim 1 wherein the used glass cullet is a product of magnetic separation.

8. A method as in claim 1 wherein the used glass cullet is a product of eddy current separation.

9. A method as in claim 1 further comprising:
dispensing into the furnace, another used glass cullet from another used solar module.

10. A method as in claim 9 wherein the reading is also of the another used glass cullet.

11. A method as in claim 10 wherein processing the reading comprises statistical sampling.

12. A method as in claim 10 wherein processing the reading comprises referencing a database created from testing.

13. A method as in claim 10 wherein processing the reading comprises machine learning.

14. A method as in claim 9 further comprising:
receiving a previous reading of optical interrogation of the used glass cullet; and
prior to the dispensing, storing the used glass cullet based on the previous reading.

15. A method as in claim 14 wherein the used glass cullet and the another used glass cullet are stored as separate batches.

16. A method as in claim 15 wherein the used glass cullet and the another used glass cullet:
have different elemental content;
have different transmittance; and/or
result from different pre-processing.

17. A method as in claim 9 wherein the another used glass cullet is a product of magnetic separation.

18. A method as in claim 9 wherein the another used glass cullet is a product of Eddy current separation.

19. A method as in claim 9 wherein:
the furnace melts the used glass cullet and the another used glass cullet into a glass formulation; and
the method further comprises:
making a new solar module from the glass formulation.

20. A method as in claim 19 wherein the new solar module is made from a sugar cullet of the glass formulation.
